(19) United States
(12) Patent Application Publication
(10) Pub. No.: US 2020/0118499 A1
(43) Pub. Date: Apr. 16, 2020

(54) DISPLAY DRIVING METHOD, DISPLAY DRIVING DEVICE, DATA DRIVING CIRCUIT AND DISPLAY DEVICE

(71) Applicants: CHENGDU BOE OPTOELECTRONICS TECHNOLOGY CO., LTD., Chengdu (CN); BOE TECHNOLOGY GROUP CO., LTD., Beijing (CN)

(72) Inventors: Na Zhang, Beijing (CN); Bin Zhang, Beijing (CN); Jing Wang, Beijing (CN)

(21) Appl. No.: 16/512,763

(22) Filed: Jul. 16, 2019

(30) Foreign Application Priority Data
Oct. 11, 2018 (CN) 201811184765.X

(51) Int. Cl. G09G 3/3283; G09G 3/3233; G09G 3/3258

(52) U.S. Cl. CPC G09G 3/3283; G09G 3/3258; G09G 3/3233

(57) ABSTRACT

A display driving method, a display driving device, a data driving circuit, a display device, and a storage medium are disclosed. The display driving method is used for driving a display panel to perform display operation, and includes: determining an output driving parameter according to a magnitude of display power consumption of the display panel during displaying of an input image that is received; and when a data signal corresponding to the input image is outputted to the display panel, adjusting a magnitude of a driving current generated by output of the data signal according to a value of the output driving parameter.

The present application claims the priority to Chinese patent application No. 201811184765.X, filed on Oct. 11, 2018, the entire disclosure of which is incorporated herein by reference as part of the present application.

### TECHNICAL FIELD

Embodiments of the present disclosure relate to a display driving method, a display driving device, a data driving circuit, and a display device.

### BACKGROUND

A liquid crystal display device (LCD), as the most common flat panel display device, has been widely used in various application scenarios. An Organic Light-Emitting Diode (OLED) display device is gradually attract wide attention of people owing to its advantages of wide viewing angle, high contrast ratio, fast response speed, and higher luminance and lower driving voltage relative to an inorganic light-emitting display device, etc. The liquid crystal display device and the organic light-emitting diode display device are suitable for a mobile phone, a display, a notebook computer, a digital camera, an instrument and a meter, and other devices with display function.

### SUMMARY

At least one embodiment of the present disclosure provides a display driving method, for driving a display panel to perform display operation, comprising: determining an output driving parameter according to a magnitude of display power consumption of the display panel during displaying an input image that is received; and when a data signal corresponding to the input image is outputted to the display panel, adjusting a magnitude of a driving current generated by output of the data signal according to a value of the output driving parameter.

For example, in a display driving method provided by an embodiment of the present disclosure, the determining the output driving parameter according to the magnitude of the display power consumption of the display panel during displaying the input image that is received comprises: decompressing the input image so as to obtain image data of the input image, and the image data obtained by decompressing the input image are used to judge the display power consumption of the display panel during displaying the input image that is received.

For example, in a display driving method provided by an embodiment of the present disclosure, the determining the output driving parameter according to the magnitude of the display power consumption of the display panel during displaying the input image that is received comprises: comparing image data of the input image with at least one reference datum, and determining the output driving parameter according to a comparison result.

For example, in a display driving method provided by an embodiment of the present disclosure, the reference datum comprises pixel grayscale values of a reference image, the image data of the input image comprises pixel grayscale values of the input image, and the comparing image data of the input image with at least one reference datum comprises: comparing the pixel grayscale values of the input image with the pixel grayscale values of the reference image.

For example, in a display driving method provided by an embodiment of the present disclosure, the reference datum comprises a reference threshold, the image data of the input image comprises pixel grayscale values of the input image, and the comparing image data of the input image with at least one reference datum comprises: computing the pixel grayscale values of the input image to obtain a comparison value, and comparing the comparison value with the reference threshold.

For example, in a display driving method provided by an embodiment of the present disclosure, the comparison value comprises a mean or a weighted mean of the pixel grayscale values of the input image.

For example, in a display driving method provided by an embodiment of the present disclosure, the output driving parameter is expressed as a level of the display power consumption based on the magnitude of the display power consumption.

For example, in a display driving method provided by an embodiment of the present disclosure, the adjusting the magnitude of the driving current generated by output of the data signal according to the value of the output driving parameter comprises: adjusting the magnitude of the driving current generated by output of the data signal according to a level of the display power consumption.

For example, in a display driving method provided by an embodiment of the present disclosure, the adjusting the magnitude of the driving current generated by output of the data signal according to the level of the display power consumption comprises: adjusting the driving current to render the magnitude of the driving current to increase when the level of the display power consumption becomes higher; and adjusting the driving current to render the magnitude of the driving current to decrease when the level of the display power consumption becomes lower.

At least one embodiment of the present disclosure further provides a display driving device, for driving display operation of a display panel, comprising: a processing circuit, configured to determine an output driving parameter according to magnitude of display power consumption of the display panel during displaying an input image that is received; and an outputting circuit, configured to output a data signal corresponding to the input image during the display operation of the display panel, and to adjust a magnitude of a driving current generated by output of the data signal according to a value of the output driving parameter.

For example, in a display driving device provided by an embodiment of the present disclosure, the outputting circuit comprises: a decoding circuit, configured to receive the output driving parameter, and to generate a control signal according to the output driving parameter; and a data driving circuit, configured to output the data signal corresponding to the input image, and to adjust the magnitude of the driving current generated by output of the data signal according to the control signal.

For example, in a display driving device provided by an embodiment of the present disclosure, the data driving circuit comprises an output buffering circuit; and the output buffering circuit is configured to output the data signal based on a pixel grayscale value of the input image according to a predetermined timing, and to adjust the magnitude of the driving current generated by output of the data signal according to the control signal.

For example, in a display driving device provided by an embodiment of the present disclosure, the output buffering circuit comprises a plurality of first input terminals, a second input terminal, and a plurality of output terminals; and the plurality of first input terminals are configured to receive the control signal, the second input terminal is configured to receive a grayscale voltage corresponding to the pixel grayscale value, and the plurality of output terminals output a data signal corresponding to the pixel grayscale value.

For example, in a display driving device provided by an embodiment of the present disclosure, the decoding circuit comprises a one-of-N decoder; and the one-of-N decoder is configured to provide the control signal to the data driving circuit, and N is an integer greater than one.

For example, in a display driving device provided by an embodiment of the present disclosure, the processing circuit comprises a decompression circuit; and the decompression circuit is configured to decompress the input image so as to obtain image data of the input image, and the image data obtained by decompressing the input image are used to judge the display power consumption of the display panel during displaying the input image that is received.

For example, in a display driving device provided by an embodiment of the present disclosure, the processing circuit further comprises a comparison circuit; and the comparison circuit is configured to compare image data of the input image with at least one reference datum, and to determine the output driving parameter according to a comparison result.

At least one embodiment of the present disclosure further provides a data driving circuit, for driving display operation of a display panel, comprising: an outputting circuit, configured to output a data signal corresponding to an input image during the display operation of the display panel, and to adjust a magnitude of a driving current generated by output of the data signal according to a value of an output driving parameter, and the output driving parameter is determined according to a magnitude of display power consumption of the display panel during displaying an input image that is received.

At least one embodiment of the present disclosure further provides a display device, comprising: a display panel; and the display driving device provided by the embodiment of the present disclosure, for driving the display panel to perform display operation, the display panel comprises a plurality of data lines, and the plurality of data lines are connected to the display driving device, so as to respectively receive the data signal corresponding to the input image for the display operation.

At least one embodiment of the present disclosure further provides a non-volatile storage medium, the storage medium is configured to store computer instructions executable by a processor, and the computer instructions are capable of being executed by the processor to implement the display driving method provided by the embodiment of the present disclosure.

### BRIEF DESCRIPTION OF THE DRAWINGS

In order to demonstrate clearly technical solutions of the embodiments of the present disclosure, the accompanying drawings in relevant embodiments of the present disclosure will be introduced briefly. It is apparent that the drawings may only relate to some embodiments of the disclosure and not intended to limit the present disclosure.

FIG. 1 is a schematic diagram illustrating a mosaic image and corresponding grayscale voltages;

FIG. 2A is a schematic diagram in which a load of a display panel is equivalent to a RC circuit;

FIG. 2B is a schematic diagram illustrating impact of a driving current on a charging time;

FIG. 2C is a schematic diagram illustrating a connection relationship between a data driving circuit and a display panel;

FIG. 3 is a schematic diagram illustrating a display driving method provided by an embodiment of the present disclosure;

FIG. 4 is another schematic diagram illustrating a display driving method provided by an embodiment of the present disclosure;

FIG. 5 is a schematic diagram illustrating a display driving device provided by an embodiment of the present disclosure;

FIG. 6 is a schematic diagram illustrating another display driving device provided by an embodiment of the present disclosure;

FIG. 7 is a schematic diagram illustrating an outputting circuit in a display driving device provided by an embodiment of the present disclosure;

FIG. 8 is a schematic diagram illustrating an output buffering circuit in a display driving device provided by an embodiment of the present disclosure;

FIG. 9 is a schematic diagram illustrating a display device provided by an embodiment of the present disclosure; and

FIG. 10 is a schematic diagram illustrating a storage medium provided by an embodiment of the present disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is apparent that the described embodiments are just a part but not all of the embodiments of the disclosure. Based on the described embodiments herein, those skilled in the art can obtain other embodiment, without any creative work, which shall be within the scope of the disclosure.

Unless otherwise defined, all the technical and scientific terms used herein have the same meanings as commonly understood by one of ordinary skill in the art to which the present disclosure belongs. The terms, such as “first,” “second,” or the like, which are used in the description and the claims of the present disclosure, are not intended to indicate any sequence, amount or importance, but for distinguishing various components. The terms, such as “comprise/comprising,” “include/including,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not limited to a physical connection or mechanical connection, but may include an electrical connection/coupling, directly or indirectly. The terms, “on,” “under,” “left,” “right,” or the like are only used to indicate relative position relationship, and when the position of the object which is described is changed, the relative position relationship may be changed accordingly.

A liquid crystal display device generally adopts an active matrix driving mode, and includes pixel units arranged in matrix, and for example, each row of pixel units corresponds to a same gate line, and each column of pixel units corresponds to a same data line. Each of the pixel units includes a thin film transistor functioning as a switching element and a pixel electrode and a common electrode for controlling alignment of liquid crystals, and the pixel electrode and the common electrode form a liquid crystal capacitor. In the process of display operation, a data driving circuit charges and discharges the liquid crystal capacitor of each pixel unit through a corresponding data line. The active matrix driving mode generally adopts a progressive scanning mode in which one row of pixel units is all turned on in each scanning operation. The data driving circuit writes data signals (voltage signals) to all of the row of pixel units through corresponding data lines, thus realizing writing and displaying of one frame of image.

A pixel driving circuit in an OLED display device also adopts a matrix driving mode in general, which is classified into an Active Matrix (AM) driving and a Passive Matrix (PM) driving according to whether or not a switching component is introduced into each pixel unit. The pixel driving circuit of each pixel unit of the AMOLED includes a set of thin film transistors and a storage capacitor, and control of current flowing through OLEDs is realized by driving control of the thin film transistors and the storage capacitor, thereby causing the OLEDs to emit light based on the required brightness. Likewise, during the process of display operation, the data driving circuit charges and discharges the storage capacitor of each pixel unit through a corresponding data line. The active matrix driving mode generally adopts a progressive scanning mode to realize the writing and displaying of one frame of image. As compared with the passive matrix driving mode, the AMOLED requires small driving current, has low power consumption and longer lifetime, which can meet the demands of high resolution and multi-grayscale for large-scale display. In addition, the AMOLED has obvious advantages in viewing angle, color rendition, power consumption, response time and other aspects, and is suitable for display devices with high information content and high resolution.

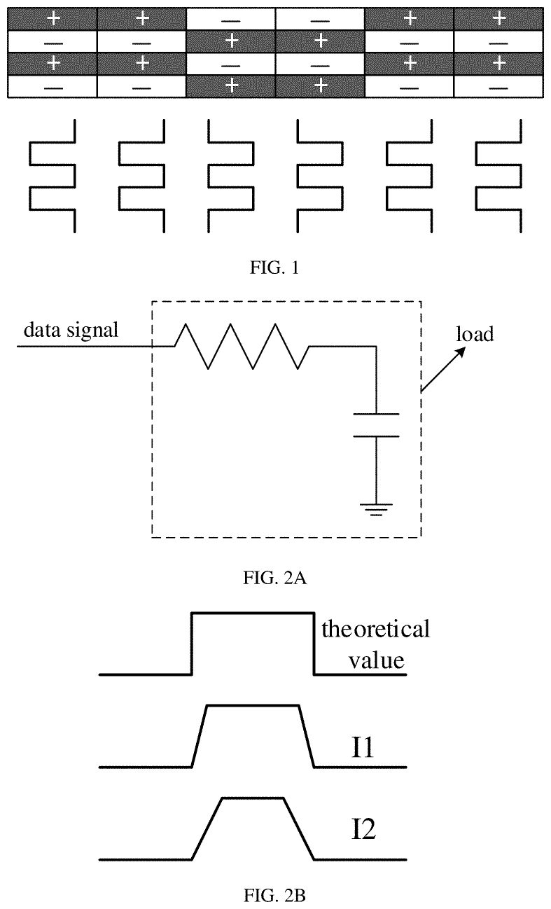

When a display driving device (e.g., a driving IC) is used for driving an Organic Light-Emitting Diode (OLED) display device to display, the power consumption of the display device is directly proportional to reverse amplitude and reverse frequency of a grayscale voltage provided by the display driving device. For example, as shown in FIG. 1, when a mosaic image (as shown in a upper part of FIG. 1) is displayed by the display device, the grayscale voltage (as shown in a lower part of FIG. 1) provided by the display driving device is switched between a highest voltage and a lowest voltage once per row. The power consumption of the display device is increased when a mosaic image similar to that in FIG. 1 is displayed by the display device.

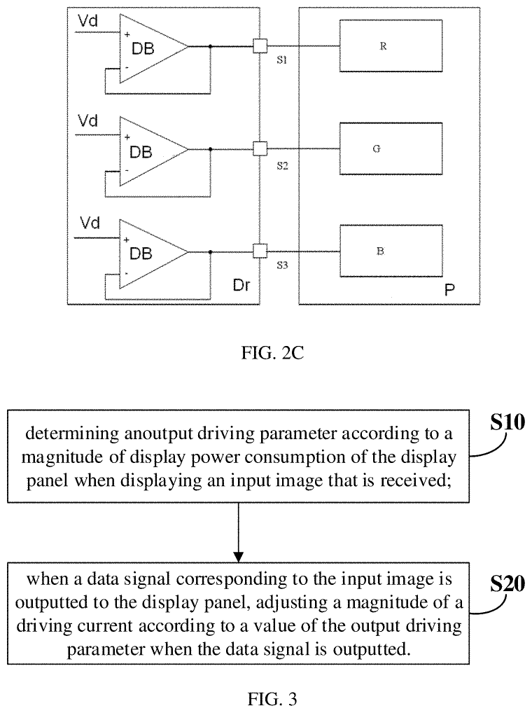

In an actual display operation, as shown in FIG. 2A, a load of each pixel unit of a display panel can be equivalent to a RC circuit (a circuit in which a resistor and a capacitor are connected in series with each other), or a load of the whole display panel is equivalent to a RC circuit. The data signal provided by the display driving device includes a grayscale voltage for controlling display brightness, and the grayscale voltage controls a displayed image of the display panel and cannot be changed, otherwise display defects will result; in addition, the data signal further includes a driving current for driving the load of the display panel, and the magnitude of the driving current affects a charging time of the capacitor.

For example, as shown in FIG. 2B, in a case where the driving current is a theoretical value, the driving current has no delay in driving the load of the display panel, and the driving current charges the load of the display panel of the longest time, so that the voltage written into the pixel unit can be closer to the theoretical grayscale voltage. For example, the driving current I2 is smaller than the driving current I1 in FIG. 2B, and as shown in FIG. 2B, when the driving current is 12, the delay of the driving current is relatively large relative to the case where the driving current is I1. Moreover, because the turn-on time of pixel units of each row of the display panel is fixed, when the delay of the driving current is relatively large, the charging time of the load in the display panel by the driving current is reduced, and charges charged within unit time are less. Thus, the difference between the voltage written into the pixel unit and the theoretical grayscale voltage is relatively large, which may adversely affect the display effect.

A data driving circuit for a LCD display panel or an OLED display panel receives a data signal and a control signal that are provided by a controller (e.g., a timing controller), and converts the data signal in digital form into a corresponding analog grayscale voltage signal by digital-to-analog conversion (DAC), and then inputs the analog grayscale voltage signal into a pixel circuit of the display panel to realize display. For example, the data driving circuit may include a gamma correction and grayscale voltage generating circuit, a data latch circuit, a grayscale voltage selecting circuit, an output buffer, etc. The output buffer is connected to data lines in the display panel, and may include an analog buffer amplifying circuit, so as to improve the load-carrying capacity of the data voltage subjected to the DAC conversion.

As shown in FIG. 2C, the data driving circuit Dr includes a plurality of output buffers DBs, and the display panel P includes columns of pixel units, for example, one of the pixel units is a red pixel unit (R), a green pixel unit (G) or a blue pixel unit (B). Each of the output buffers provides one output channel, which is connected to a data line for one column of pixel units, so that the received data signal Vd can be applied to the data line. Three output buffers DBs are illustrated in FIG. 2C, which are respectively connected to three data lines S1˜S3, for providing data signals for a red pixel unit (R), a green pixel unit (G) and a blue pixel unit (B) of one pixel, respectively, so as to charge capacitors in these pixel units. The magnitude of driving current provided by the output buffer DB is fixed and unchanged, so that the load-carrying capacity is fixed and cannot be adjusted according to the specific situation of the displayed image of the display panel.

For example, when the display device displays a image unlike the mosaic image as shown in FIG. 1, the reverse amplitude and the reverse frequency of the grayscale voltage that needs to be provided by the display driving device are no longer required to be so large, and in this case, charging time of the load in the display panel by the driving current is not required to be so long, so that the driving current provided by the display driving device can be reduced while having no significant adverse effect on the display effect.

At least one embodiment of the present disclosure provides a display driving method, for driving a display panel to perform display operation. The display driving method includes: determining an output driving parameter according to magnitude of display power consumption of the display panel during displaying an input image that is received; and when a data signal corresponding to the input image is outputted to the display panel, adjusting a magnitude of a driving current generated by output of the data signal according to a value of the output driving parameter.

At least one embodiment of the present disclosure further provides a display driving device, a data driving circuit, a display device and a non-volatile storage medium corresponding to the above-described display driving method.

The display driving method, the display driving device, the data driving circuit, the display device and the non-volatile storage medium provided by the embodiments of the present disclosure can determine the output driving parameter according to different input images received by the display panel, and then adjust the magnitude of the driving current according to the output driving parameter, thereby reducing the display power consumption of the display panel.

Embodiments of the present disclosure will be described in detail below in conjunction with attached drawings.

At least one embodiment of the present disclosure provides a display driving method, for driving a display panel to perform display operation. For example, as shown in FIG. 3, the display driving method includes the following operations.

Step S10: determining an output driving parameter according to a magnitude of display power consumption of the display panel during displaying an input image that is received; and

Step S20: when a data signal corresponding to the input image is outputted to the display panel, adjusting a magnitude of a driving current generated by output of the data signal according to a value of the output driving parameter.

For example, in step S10, when the display panel displays the input image that is received, such as one frame of input image, the magnitude of the display power consumption of the display panel during displaying the frame of input image can be judged firstly, so as to determine the output driving parameter.

For example, in one example, the output driving parameter can be expressed as a level of the display power consumption according to the magnitude of the display power consumption. For example, the magnitude of the display power consumption can be classified into two levels, which are expressed as 0 and 1, respectively. For example, 0 indicates that the display power consumption is lower, while 1 indicates that the display power consumption is larger. For another example, in another example, the magnitude of the display power consumption can further be classified more fine, and for example, can be classified into eight levels, which are expressed as 0, 1, 2, 3, 4, 5, 6 and 7, respectively, 0 indicates that the display power consumption is lowest, and 7 indicates that the display power consumption is highest. It should be noted that, the embodiments of the present disclosure do not limit the representative method of the output driving parameter, and it can be processed according to the actual situation.

For example, after the output driving parameter is obtained in step S10, in step S20, when the data signal corresponding to the input image is outputted to the display panel, the magnitude of the driving current generated by output of the data signal can be adjusted according to the value of the output driving parameter.

For example, in an example, in step S20, the adjusting the magnitude of the driving current generated by output of the data signal according to the value of the output driving parameter includes: adjusting the magnitude of the driving current generated by output of the data signal according to the level of display power consumption.

For example, the adjusting the magnitude of the driving current generated by output of the data signal according to the level of display power consumption as stated above includes: the driving current is adjusted to be increased when the level of the display power consumption becomes higher; and the driving current is adjusted to be decreased when the level of display power consumption becomes lower.

For example, in one example, step S10 and step S20 can be executed by using a display driving device provided by an embodiment of the present disclosure. For example, the display driving device can be implemented as a driving IC (integrated circuit). For example, in one example, the magnitude of the display power consumption is represented as two levels, and for example, in step S10, the output driving parameter obtained by the display driving device is 1, which indicates that the display panel has a larger display power consumption for an input image currently to be displayed by the display panel. Then in step S20, the display driving device can adjust the driving current when outputting the data signal, thereby causing the value of the driving current to become smaller, for example, the driving current is increased by the adjustment. For another example, in step S10, the output driving parameter obtained by the display driving device is 0, which indicates that the display panel has a smaller display power consumption for an input image currently to be displayed by the display panel. Then in step S20, the display driving device can adjust the driving current when outputting the data signal, thereby causing the value of the driving current to become smaller, for example, the driving current is decreased by the adjustment.

The display driving method provided by the embodiment of the present disclosure can determine the output driving parameter according to the magnitude of the display power consumption of the display panel during displaying the input image that is received, and then, when the data signal corresponding to the input image is outputted to the display panel, the magnitude of the driving current can be adjusted according to the value of the output driving parameter. Thus, the driving current can be reduced in a case where the display panel does not need a larger driving current, thereby reducing the power consumption of the display panel. Because the display driving method does not adjust the grayscale voltage corresponding to the data signal, it will not affect the normal display of the input image.

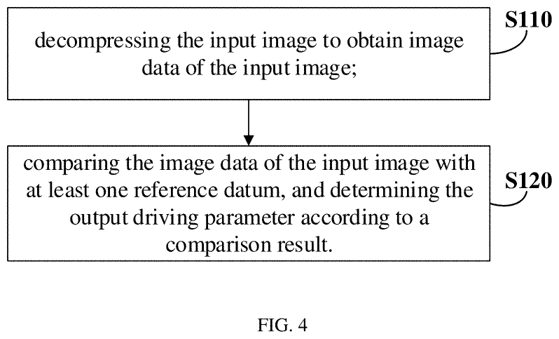

In one example of the present disclosure, the input image obtained by the display device through a receiving device (e.g., a modem) is data in a certain compressed format, such as video data based on the standard such as M-JPEG, H.261/H.263, MPEG or the like, or static image data based on JPEG, etc. and before the input image that is received is displayed on the display panel, the input image that is received needs to be decompressed. In this example, as shown in FIG. 4, step S10 can include the following operation.

Step S110: decompressing the input image to obtain image data of the input image.

After that, the image data obtained by decompressing the input image are used to judge the display power consumption of the display panel during displaying the input image that is received.

With the aim of reducing the amount of data for transmission of the input image and improving the transmission efficiency, the input image generally provided to the display driving device (e.g. a driving IC) is compressed data, so that in step S110, the input image is decompressed firstly to obtain the decompressed image data of the input image. For example, the decompressed image data includes all the information required by the display panel to display the input image, and for example, the decompressed image data can be pixel grayscale values corresponding to the input image. For example, in a case where a total of 256 pixel grayscale values are to be represented from 0 to 255, the decompressed image data can be represented as 8-bit binary data.

In some embodiments of the present disclosure, the input image can also be uncompressed, such as an image with a BMP format, so that in these embodiments, the image data of the input image can be obtained without compression.

For example, as shown in FIG. 4, step S10 can further include the following operation.

Step S120: comparing the image data of the input image with at least one reference datum, and determining the output driving parameter according to a comparison result.

The image data of the input image are obtained by decompression in a case where the input image is in a compressed format, and are obtained by directly reading in a case where the input image is in an uncompressed format.

For example, in one example, the reference datum is pixel grayscale values of a reference image, and the image data of the input image are pixel grayscale values of the input image. The comparing the image data of the input image with at least one reference datum includes step S121: comparing the pixel grayscale values of the input image with the pixel grayscale values of the reference image. For example, in one example, in step S121, each of the pixel grayscale values of the input image is compared with a corresponding pixel grayscale value of the reference image.

For example, the mosaic image as shown in FIG. 1 can be adopted as the reference image. In step S120, each of the pixel grayscale values of the input image can be compared with a corresponding pixel grayscale value of the mosaic image one by one. For example, as stated above, in the case where the output driving parameter is represented as two levels of 0 and 1, and in a case where the pixel grayscale values of the input image are exactly the same or approximately the same as the pixel grayscale values of the reference image (e.g., the mosaic image), the output driving parameter determined in step S120 is 1; and in a case where the pixel grayscale values of the input image are different from the pixel grayscale values of the reference image (e.g., the mosaic image), the output driving parameter determined in step S120 is 0.

It should be noted that, in the embodiments of the present disclosure, for example, the pixel grayscale values of the input image being approximately the same as the pixel grayscale values of the reference image may include that, pixel grayscale values of the input image are 80% or above the same as the pixel grayscale values of the reference image, or the pixel grayscale values of the input image are 90% or above the same as the pixel grayscale values of the reference image, and the embodiments of the present disclosure do not limit this.

For example, in one example, the reference datum includes a reference threshold, and the image data of the input image include the pixel grayscale values of the input image. Then the comparing the image data of the input image with at least one reference datum includes step S122: computing the pixel grayscale values of the input image to obtain a comparison value, and comparing the comparison value with the reference threshold.

For example, in one example, the pixel grayscale values of the input image can be computed to obtain a mean (or a weighted mean) of the pixel grayscale values of the input image, and the mean is used as the comparison value, then the comparison value is compared with the reference threshold, e.g., the reference threshold is 127. The reference threshold can be selected according to the actual situation, and the embodiments of the present disclosure do not limit this.

In the above descriptions, each of the embodiments has been illustrated with one reference datum as an example, and the embodiments of the present disclosure do not limit an amount of the reference datum. For example, two reference datum can also be used, and for example, the two reference datum are a reference datum A and a reference datum B. Upon comparison, the image data of the input image are compared with each of the reference datum A and the reference datum B, and the output driving parameter is determined according to comparison results. The accuracy of determining the output driving parameter can be improved by using this method.

In the display driving method provided by some embodiments of the present disclosure, the input image can be decompressed firstly to obtain the decompressed image data of the input image, and for example, the decompressed image data are pixel grayscale values of the input image; next, the decompressed image data are compared with at least one reference datum, so as to determine the output driving parameter.

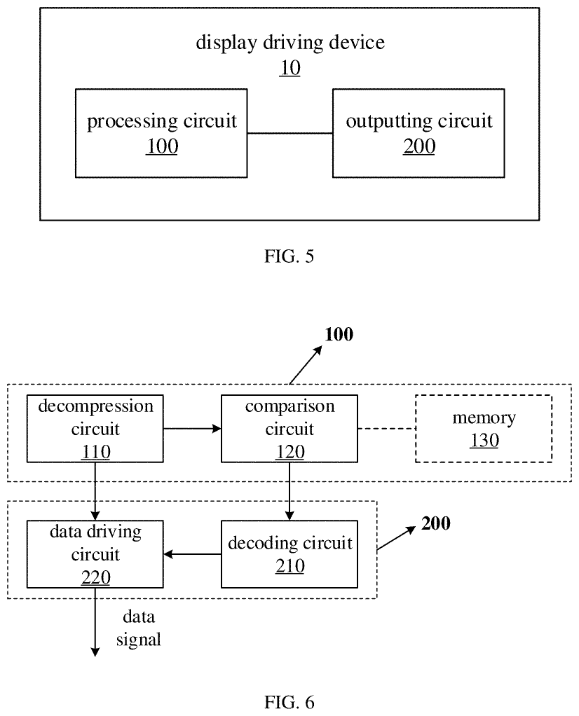

At least one embodiment of the present disclosure further provides a display driving device 10, for driving display operation of a display panel. As shown in FIG. 5, the display driving device 10 includes a processing circuit 100 and an outputting circuit 200.

For example, the processing circuit 100 is configured to determine an output driving parameter according to magnitude of display power consumption of the display panel during displaying an input image that is received. That is, the above step S10 can be performed by the processing circuit 100, so as to obtain the output driving parameter.

For example, in one example, as shown in FIG. 6, the processing circuit 100 includes a decompression circuit 110, which is configured to decompress the input image so as to obtain decompressed image data of the input image, and the decompressed image data of the input image are used to judge the display power consumption of the display panel during displaying the input image that is received. That is, the above step S110 can be performed by the decompression circuit 110.

As shown in FIG. 6, the processing circuit further includes a comparison circuit 120, which is configured to compare the decompressed image data of the input image with at least one reference datum, and to determine the output driving parameter according to a comparison result. That is, the above step S120 can be performed by the comparison circuit 120. For example, in a different example, the comparison circuit 120 can perform step S121 and step S122 as stated above. For example, the comparison circuit 120 is connected to the compression circuit 110, so that the comparison circuit can obtain the decompressed image data from the decompression circuit 110.

As shown in FIG. 6, the processing circuit 100 can further include a memory 130 connected to the comparison circuit 120. For example, at least one reference datum can be stored in the memory 130 in advance, and the comparison circuit 120 can call the reference datum directly from the memory 130 when performing the comparison, thereby accomplishing the comparison. Of course, it is also possible that the memory 130 is not provided separately, but directly provided in the comparison circuit 120, and the embodiments of the present disclosure do not limit this. For example, in some examples, the memory 130 can be implemented as a storage medium, such as a semiconductor memory, a magnetic memory, etc.

For example, as shown in FIG. 5, the outputting circuit 200 is configured to output a data signal corresponding to the input image during the display operation of the display panel, and to adjust a magnitude of a driving current generated by output of the data signal according to a value of the output driving parameter. That is, while the outputting circuit 200 outputs the data signal corresponding to the input image during the display operation of the display panel, the above step S20 can be performed to adjust the magnitude of the driving current.

For example, in one example, as shown in FIG. 6, the outputting circuit 200 includes a decoding circuit 210 and a data driving circuit 220, and the data driving circuit 220 is connected to the decoding circuit.

The decoding circuit 210 is configured to receive the output driving parameter, and to generate a control signal according to the output driving parameter. For example, the decoding circuit 210 is connected to the comparison circuit 120, so that the decoding circuit 210 can obtain the output driving parameter from the comparison circuit 120, and the decoding circuit 210 generates the control signal according to the output driving parameter, and provides the control signal to the data driving circuit 220.

The data driving circuit 220 is configured to output the data signal corresponding to the input image, and to adjust the magnitude of the driving current generated by output of the data signal according to the control signal. For example, as shown in FIG. 6, the data driving circuit 220 is connected to the decompression circuit 110, so that the data driving circuit can obtain the decompressed image data of the input image from the decompression circuit 110. For example, the decompressed image data are the pixel grayscale values of the input image, and in this case, the data driving circuit 220 can further be configured to convert the pixel grayscale values of the input image to corresponding grayscale voltages, that is, the data signal outputted by the data driving circuit 220 include information about grayscale voltages corresponding to the input image.

For example, as shown in FIG. 6, the data driving circuit 220 is connected to the decoding circuit 210, so that the data driving circuit 220 can obtain the control signal from the decoding circuit 210, and the magnitude of the driving current generated by output of the data signal is adjusted according to the control signal.

The display driving device 10 provided by at least one embodiment of the present disclosure is used for driving the display operation of the display panel. The output driving parameter can be determined according to different input images received by the display panel, and then the magnitude of the driving current is adjusted according to the output driving parameter when the display driving device 10 outputs the data signal, thereby reducing the display power consumption of the display panel.

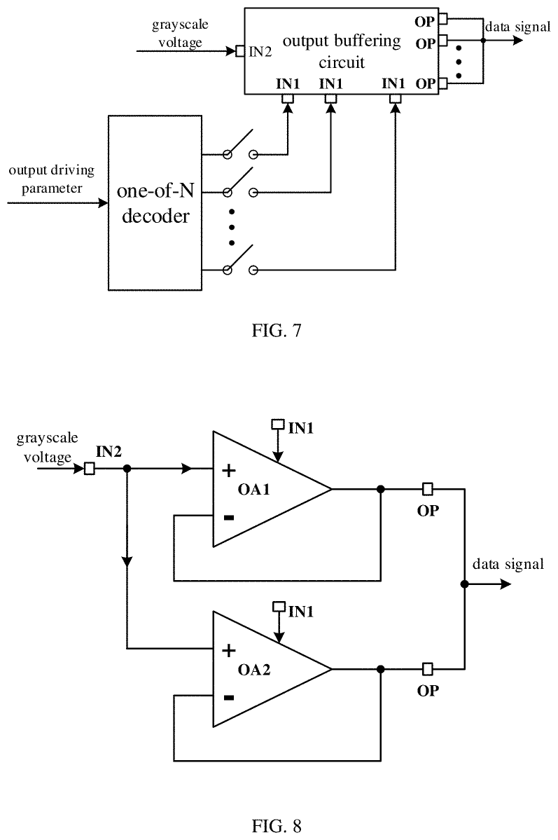

For example, in an outputting circuit 200 provided by at least one embodiment, as shown in FIG. 7, the decoding circuit 210 can be implemented as a one-of-N decoder (N is an integer greater than one), and the data driving circuit 220 can be implemented to include an output buffering circuit.

The output buffering circuit is configured to output the data signal based on a pixel grayscale value of the input image according to a predetermined timing, and to adjust the magnitude of the driving current generated by output of the data signal according to the control signal. The driving current is used for charging capacitors (storage capacitors or liquid crystal capacitors) of turn-on pixel units through a corresponding data line, so as to write the data signal into the pixel units. For example, as shown in FIG. 7, the output buffering circuit includes a plurality of first input terminals IN1, a second input terminal IN2 and a plurality of output terminals OP. The plurality of first input terminals IN1 are configured to receive the control signal which is provided by the one-of-N decoder. The second input terminal IN2 is configured to receive a grayscale voltage corresponding to the pixel grayscale value, the plurality of output terminals OP output a data signal corresponding to the pixel grayscale value, and the voltage value of the data signal outputted by the output buffering circuit is equal to the grayscale voltage value that is received.

For example, as shown in FIG. 7, the one-of-N decoder is configured to provide the control signal to the output buffering circuit of the data driving circuit 200. The one-of-N decoder includes one input terminal and a plurality of output terminals, the input terminal receives the output driving parameter, and the output driving parameter is provided by the comparison circuit 120. The plurality of output terminals of the one-of-N decoder are connected to the plurality of first input terminals IN1 of the output buffering circuit, respectively, so that outputting the control signal to the output buffering circuit is realized.

As shown in FIG. 7, in a case where the one-of-N decoder is a one-of-2 decoder, for example, the comparison circuit 120 compares the decompressed image data of the input image with the reference datum, so as to obtain the output driving parameter of 0, that is, the display power consumption of the display panel is smaller. The one-of-2 decoder can control one output terminal to output the control signal, and the control signal can, for example, act on a certain branch circuit of the output buffering circuit to make the branch circuit work. Thus, the driving current of the output buffering circuit is smaller when the data signal is outputted, thereby the power consumption of the display panel is reduced when a larger driving current is not required.

For example, in one example, the output buffering circuit in FIG. 7 can be implemented as the circuit structure in FIG. 8. In the example as shown in FIG. 8, the output buffering circuit includes a first operational amplifier OA1 and a second operational amplifier OA2.

A noninverting input terminal of the first operational amplifier OA1 and a noninverting input terminal of the second operational amplifier OA2 are both connected to the second input terminal IN2 so as to receive a grayscale voltage corresponding to the input image. An inverting input terminal of the first operational amplifier OA1 is connected to an output terminal of the first operational amplifier OA1, and an inverting input terminal of the second operational amplifier OA2 is connected to an output terminal of the second operational amplifier OA2, that is, the first operational amplifier OA1 and the second operational amplifier OA2 each adopts a connecting way of “voltage follower”, so that a voltage value of a data signal outputted by the first operational amplifier OA1 and a voltage value of a data signal outputted by the second operational amplifier OA2 are both consistent with the grayscale voltage corresponding to the input image. The output terminal of the first operational amplifier OA1 and the output terminal of the second operational amplifier OA2 are connected to a same data line DL, so that in a case where one of OA1 and OA2 works, a predetermined driving current is used to charge pixel units connected to the data line DL to a predetermined grayscale voltage.

For example, in one example, the first operational amplifier OA1 and the second operational amplifier OA2 in FIG. 8 can adopt different types of operational amplifiers, and the first operational amplifier OA1 and the second operational amplifier OA2 are configured to output different driving currents in a case where the OA1 and OA2 are connected to a same load. For example, the driving current outputted by the first operational amplifier OA1 is larger than the driving current outputted by the second operational amplifier OA2, so that the load-carrying capacity of the first operational amplifier OA1 is larger than that of the second operational amplifier OA2. For example, in one example, the control signal outputted by the one-of-N decoder (e.g., a one-of-2 decoder) can act on a voltage terminal of an operational amplifier, thereby controlling the operational amplifier to be in a working state. For example, in a case where a larger driving current needs to be outputted, the control signal outputted by the one-of-N decoder can act on the first operational amplifier OA1 to cause the first operational amplifier OA1 in a working state, and thereby a larger driving current can be outputted to charge corresponding pixel units. In a case where a smaller driving current needs to be outputted, the control signal outputted by the one-of-N decoder can act on the second operational amplifier OA2 to cause the second operational amplifier OA2 in a working state, and thereby a smaller driving current can be outputted to charge corresponding pixel units.

In another example, the output buffering circuit can be implemented as a V/I conversion circuit, which includes an operational amplifier, a regulating resistor, etc. An output current under a predetermined output voltage can be adjusted by changing the resistance value of the regulating resistor, thereby regulating the load-carrying capacity of the output buffering circuit. The decoding circuit generates the control signal according to the output driving parameter, and provides the control signal to the data driving circuit. The data driving circuit adjusts the resistance value of the regulating resistor in the V/I conversion circuit accordingly, thereby outputting a desired driving current.

At least one embodiment of the present disclosure further provides a data driving circuit, for driving display operation of a display panel. The data driving circuit includes an outputting circuit, which is configured to output a data signal corresponding to an input image during the display operation of the display panel, and to adjust a magnitude of a driving current generated by output of the data signal according to an output driving parameter. The output driving parameter is determined according to a magnitude of display power consumption of the display panel during displaying of an input image that is received.

Regarding the description of the outputting circuit, reference can be made to the corresponding descriptions in the display driving device 10 as mentioned above, and details are omitted here.

The data driving circuit provided by at least one embodiment of the present invention is used for driving the display operation of the display panel, and the data driving circuit can adjust the magnitude of the driving current generated by output of the data signal according to the output driving parameter, thereby reducing the display power consumption of the display panel.

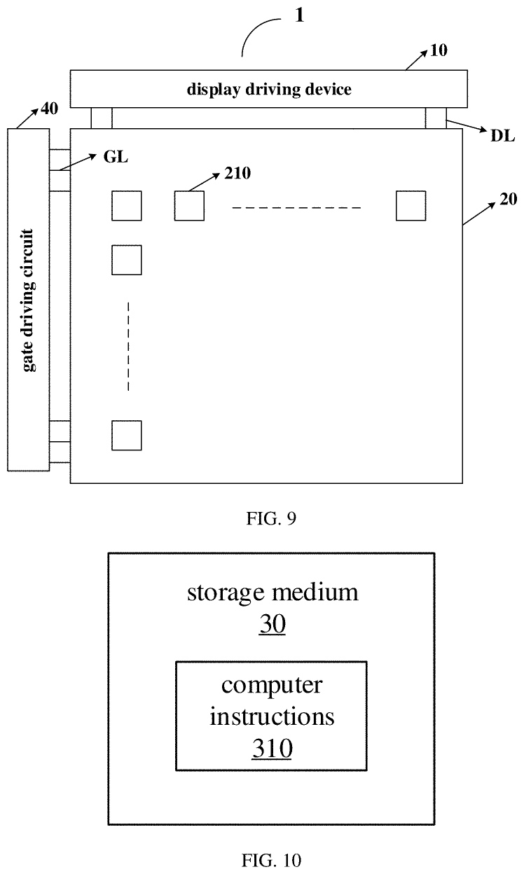

At least one embodiment of the present disclosure further provides a display device 1, as shown in FIG. 9, the display device 1 includes a display panel 20 and a display driving device 10 for driving the display panel 20 to perform display operation. For example, any display driving device 10 provided by the embodiments of the present disclosure may be adopted as the display driving device 10.

As shown in FIG. 9, the display panel 20 includes a plurality of data lines DL, and the plurality of data lines DL are connected to a plurality of output channels of the display driving device 10 so as to respectively receive data signals corresponding to the input image for display operation, and each of the output channels includes an output buffering circuit. A pixel array composed of a plurality of pixel units 210 is further disposed in the display panel 20 for display.

For example, as shown in FIG. 9, the display device 1 further includes a gate driving circuit 40, the gate driving circuit 40 is electrically connected to pixel units 210 in the display panel 20 via gate lines GL, and the gate driving circuit 40 is used to provide a scan driving signal to the pixel array, and for example, a scanning transistor in a pixel unit 210 can be driven by the driving signal.

It should be noted that the display device 1 in the embodiment can be a liquid crystal panel, a liquid crystal television, a display, an OLED panel, an OLED television, an electronic paper, a mobile phone, a tablet computer, a notebook computer, a digital photo frame, a navigator and other products or members having display function.

For the technical effects of the display device provided by the embodiment of the present disclosure, reference can be made to the description of the display driving device 10 in the above embodiments, and details are not described here again.

At least one embodiment of the present disclosure further provides a non-volatile storage medium 30, as shown in FIG. 10, which is configured to store computer instructions 310 executable by a processor, and the computer instructions 310 are capable of being executed by the processor to implement the operations of the display driving method provided by at least one embodiment of the present disclosure. For example, the operations in the above steps S10, S20, S110, S120, S121 and S122 can be performed.

For example, in one example, the storage medium 30 can be set in a computing device, which further includes a processor capable of calling computer instructions 310 stored in the storage medium 30. For example, the computing device can be implemented as a driving IC of the display device.

In the embodiments of the present disclosure, the processor can be implemented by a general-purpose integrated circuit chip or an application-specific integrated circuit chip. For example, the integrated circuit chip can be disposed on a motherboard, for example, a storage medium and a power supply circuit can be disposed on the motherboard. In addition, the processor can also be implemented by circuitry or by software, hardware (circuit), firmware, or any combination thereof. In the embodiments of the present disclosure, the processor can include a variety of computational structures, e.g., a complex instruction set computer (CISC) structure, and a reduced instruction set computing (RISC) structure or a structure that incorporates a plurality of instruction set combinations. In some embodiments, the processor can also be a CPU, a microprocessor, e.g., an X86 processor or an ARM processor, and can also be a GPU, a TPU, a digital signal processor (DSP), etc.

In the embodiments of the present disclosure, the storage medium can be disposed, for example, on the above-mentioned motherboard, the storage medium can store instructions and/or data executed by the processor, and save data generated by the running instruction, etc., and the generated data may be structured data, or unstructured data, etc. For example, the storage medium can include one or more computer program products, and the computer program product may include various forms of computer readable memory, such as non-volatile memory. The non-volatile memory may include, for example, a read-only memory (ROM), a hard disk, a flash memory, or the like. One or more computer program instructions can be stored on the computer readable memory, and the processor can execute the program instructions to implement the functions (implemented by the processor) described in the embodiments of the present disclosure.

What have been described above are only specific implementations of the present disclosure, the protection scope of the present disclosure is not limited thereto. The protection scope of the present disclosure should be based on the protection scope of the claims.

What is claimed is:

1. A display driving method, for driving a display panel to perform display operation, comprising:
determining an output driving parameter according to a magnitude of display power consumption of the display panel during displaying an input image that is received; and
when a data signal corresponding to the input image is outputted to the display panel, adjusting a magnitude of a driving current generated by output of the data signal according to a value of the output driving parameter.

2. The display driving method claimed as claim 1,
wherein the determining the output driving parameter according to the magnitude of the display power consumption of the display panel during displaying the input image that is received comprises:
decompressing the input image so as to obtain image data of the input image,
wherein the image data obtained by decompressing the input image are used to judge the display power consumption of the display panel during displaying the input image that is received.

3. The display driving method claimed as claim 1,
wherein the determining the output driving parameter according to the magnitude of the display power consumption of the display panel during displaying the input image that is received comprises:
comparing image data of the input image with at least one reference datum, and determining the output driving parameter according to a comparison result.

4. The display driving method claimed as claim 3,
wherein the reference datum comprises pixel grayscale values of a reference image, the image data of the input image comprises pixel grayscale values of the input image, and the comparing the image data of the input image with at least one reference datum comprises:
comparing the pixel grayscale values of the input image with the pixel grayscale values of the reference image.

5. The display driving method claimed as claim 3,
wherein the reference datum comprises a reference threshold, the image data of the input image comprises pixel grayscale values of the input image, and the comparing the image data of the input image with at least one reference datum comprises:
computing the pixel grayscale values of the input image to obtain a comparison value, and comparing the comparison value with the reference threshold.

6. The display driving method claimed as claim 5, wherein the comparison value comprises a mean or a weighted mean of the pixel grayscale values of the input image.

7. The display driving method claimed as claim 1, wherein the output driving parameter is expressed as a level of the display power consumption based on the magnitude of the display power consumption.

8. The display driving method claimed as claim 1, wherein the adjusting the magnitude of the driving current generated by output of the data signal according to the value of the output driving parameter comprises:
adjusting the magnitude of the driving current generated by output of the data signal according to a level of the display power consumption.

9. The display driving method claimed as claim 8,
wherein the adjusting the magnitude of the driving current generated by output of the data signal according to the level of the display power consumption comprises:
adjusting the driving current to render the magnitude of the driving current to increase when the level of the display power consumption becomes higher; and
adjusting the driving current to render the magnitude of the driving current to decrease when the level of the display power consumption becomes lower.

10. A display driving device, for driving display operation of a display panel, comprising:
a processing circuit, configured to determine an output driving parameter according to a magnitude of display power consumption of the display panel during displaying an input image that is received; and
an outputting circuit, configured to output a data signal corresponding to the input image during the display operation of the display panel, and to adjust a magnitude of a driving current generated by output of the data signal according to a value of the output driving parameter.

11. The display driving device claimed as claim 10, wherein the outputting circuit comprises:
a decoding circuit, configured to receive the output driving parameter, and to generate a control signal according to the output driving parameter; and
a data driving circuit, configured to output the data signal corresponding to the input image, and to adjust the magnitude of the driving current generated by output of the data signal according to the control signal.

12. The display driving device claimed as claim 11, wherein the data driving circuit comprises an output buffering circuit; and
the output buffering circuit is configured to output the data signal based on a pixel grayscale value of the input image according to a predetermined timing, and to adjust the magnitude of the driving current generated by output of the data signal according to the control signal.

13. The display driving device claimed as claim 12, wherein the output buffering circuit comprises a plurality of first input terminals, a second input terminal, and a plurality of output terminals; and
the plurality of first input terminals are configured to receive the control signal, the second input terminal is configured to receive a grayscale voltage corresponding to the pixel grayscale value, and the plurality of output terminals output a data signal corresponding to the pixel grayscale value.

14. The display driving device claimed as claim 11, wherein the decoding circuit comprises a one-of-N decoder; and
the one-of-N decoder is configured to provide the control signal to the data driving circuit, and
N is an integer greater than one.

15. The display driving device claimed as claim 10, wherein the processing circuit comprises a decompression circuit; and
the decompression circuit is configured to decompress the input image so as to obtain image data of the input image, and the image data obtained by decompressing the input image are used to judge the display power consumption of the display panel during displaying the input image that is received.

16. The display driving device claimed as claim 10, wherein the processing circuit further comprises a comparison circuit; and
the comparison circuit is configured to compare image data of the input image with at least one reference datum, and to determine the output driving parameter according to a comparison result.

17. The display driving device claimed as claim 15, wherein the processing circuit further comprises a comparison circuit; and
the comparison circuit is configured to compare the image data of the input image with at least one reference datum, and to determine the output driving parameter according to a comparison result.

18. A data driving circuit, for driving display operation of a display panel, comprising:
an outputting circuit, configured to output a data signal corresponding to an input image during the display operation of the display panel, and to adjust a magnitude of a driving current generated by output of the data signal according to a value of an output driving parameter,
wherein the output driving parameter is determined according to a magnitude of display power consumption of the display panel during displaying an input image that is received.

19. A display device, comprising:
a display panel; and
the display driving device claimed as claim 10, for driving the display panel to perform display operation,
wherein the display panel comprises a plurality of data lines, and the plurality of data lines are connected to the display driving device, so as to respectively receive the data signal corresponding to the input image for the display operation.

20. A non-volatile storage medium, wherein the storage medium is configured to store computer instructions executable by a processor, and the computer instructions are capable of being executed by the processor to implement the display driving method claimed as claim 1.
